(19) United States
(12) Patent Application Publication
(10) Pub. No.: US 2005/0040792 A1
(43) Pub. Date: Feb. 24, 2005

(54) Method & apparatus for charging, discharging and protection of electronic battery cells

(76) Inventor: Rajendran Nair, Gilbert, AZ (US)

Correspondence Address: Raj Nair;ComLSI Inc., 3838 E. Encinas Ave., Gilbert, AZ, 85234, US

(21) Appl. No.: 10/714,424

(22) Filed: Nov. 17, 2003

Related U.S. Application Data
(60) Provisional application No. 60/495,835, filed on Aug. 18, 2003.

(51) Int. Cl. H02J 7/00

(52) U.S. Cl. 320/162

(57) ABSTRACT

A battery cell charge/discharge and protection circuit and system employing enhancement-mode junction-gated transistors as gating switches and minimizing external components is disclosed. The use of an enhancement-mode switch device with a PN junction control gate enables the elimination of external or internal precision resistors through the compensation of the voltage drop across the switch with the forward drop across the PN junction for temperature invariance of switch channel current estimation. The use of variable current drive circuits combined with a capacitor connected to the gate of the switch device facilitates energy consumption optimization while providing a timing mechanism for determining the recovery duration after a fault condition. Elimination of precision resistors and the minimization of the capacitance value facilitate a low-cost, single-chip battery protection solution.

### TECHNICAL FIELD OF THE INVENTION

Embodiments of the invention relate to electronic circuitry commonly employed to protect and regulate the charging and discharging of electronic battery cells such as Lithium-Ion or Lithium-Polymer cells. Such circuitry falls under the broad category of power management electronics.

### BACKGROUND & PRIOR ART

Many implementations for the regulated charging/discharging and protection of battery cells exist in the prior art. Most common among these is a circuit configuration employing a gating device, a monitor/controller IC and a few external components. The gating device is typically a series combination of two MOSFET devices inserted into the battery-cell current path. The external components are typically a precision resistor employed for current measurement and capacitor elements for supply decoupling, referencing and delay programming. The Monitor/Controller IC (MCIC) controls the gate inputs of the switch device to connect or disconnect the battery to the load, and tropically monitors conditions such as Over-Voltage (OV), Over Current (OC), Under Voltage (UV) and serves to protect the battery cell from damage. The battery cell and the circuit configuration that protects it are in combination referred to as a battery pack.

The gating switch of a battery pack typically consists of two MOSFET devices in series in the prior art. This is because of the inherent body-diode within these devices that presents low impedance to current flow in one direction. In order to ensure high impedance for the switch when it is turned ‘OFF’ by a control signal from the MCIC, two MOSFET devices are connected in series such that their body diodes are back to back. This quadruples the required semiconductor area for a given ‘ON’ resistance specification. A device with no body diode, constructed as a JFET has been proposed recently by Lovoltech Inc. of San Jose, Calif. freference 7]. These JFET devices are fabricated such that there is no body diode, and are of two types—a depletion-mode device (Normally-ON) and an enhancement-mode device (Normally OFF) as described in published data sheets currently presented at a web page www.lovoltech.com. The benefit of a reduction in the required silicon area through the use of a depletion mode JFET as the gating switch in a battery pack application has been claimed. The depletion mode device also resembles a MOSFET device in its electrical nature, presenting high static impedance to the driving circuitry under all conditions of this application.

While the depletion mode device functions well as a switch under normal conditions of circuit operation, it requires the supply of a negative voltage with respect the ground node of the battery circuit in the event of a short circuit at the output of the battery pack in order to effectively turn the device ‘OFF’. This places additional requirements such as negative voltage generation and drive circuitry within the MCIC as well as an internal or external capacitor to store this negative voltage to be supplied to the switch device in the event of a short circuit. Alternate embodiments also proposed in the art may employ external resistors and capacitors with a drive circuit that provides pulses into these components to produce an effective negative voltage at the gate of the switch device. In addition to the complexity and cost of such implementations, the reliability of the turn-off action by the MCIC in the event of a short circuit may also be dependent upon the external components used for the negative voltage capability. The added complexity of and dependence upon external components is not a desirable solution for battery packs.

The invention specifies control/drive circuitry within the MCIC enabling the use of enhancement JFET devices as gating switches and minimizing the number of external components required.

### SUMMARY OF THE INVENTION

The invention is a novel circuit configuration for battery cell management within battery packs, employing sense and control circuitry that enables the use of enhancement-mode devices with PN junctions as the control gate and minimizes external components required.

FIG. 1 illustrates a system-level embodiment of the invention. The circuit configuration and the components within are commonly referred to as a battery-pack. As can be seen, the switch S controlled by the monitor/controller IC (MCIC) interrupts the circuit path from the battery cell to the load devices. A capacitor C is the only additional component utilized for the dual purpose of maintaining the gate voltage at pin VG under normal operating conditions as well as to determine a delay before a ‘reset’ action that transitions the system from a protected (shut-off) mode to a stand-by mode in the event of a load device short circuit. The concept of a dual function for the capacitor minimizes the number of components required, and in conjunction with the use of an enhancement-mode JFET device, for example, enables a much smaller value of capacitance and facilitates total component integration.

Prior art implementations also include either an external precision resistor (for load current sense, a critical function of battery packs) or an internal, trimmed resistance for the same purpose, both of which add another pin to the MCIC, integrated circuit area within the MCIC and cost. The invention does not require this external or internal resistor because it is capable of reasonably accurate load current measurements through the switch S by means of the availability of the voltages at the three terminals of the switch device as well as information about the control input current to the PN junction gate of the switch device. Again, the use of an enhancement-mode device with a PN junction control input as the gating switch in the system leads to this advantage.

### BRIEF DESCRIPTION OF THE FIGURES

FIG. 1 is one possible embodiment of the invention using a discrete gating switch device, a discrete capacitor and a control integrated circuit (IC).

FIG. 2 is an illustration of the variable current drive and the dual-function capacitor combination connecting to an enhancement-mode JFET.

FIG. 3 is an illustration of the variation of the channel conduction voltage drop and the PN junction forward voltage drop with temperature.

### DETAILED DESCRIPTION OF THE INVENTION

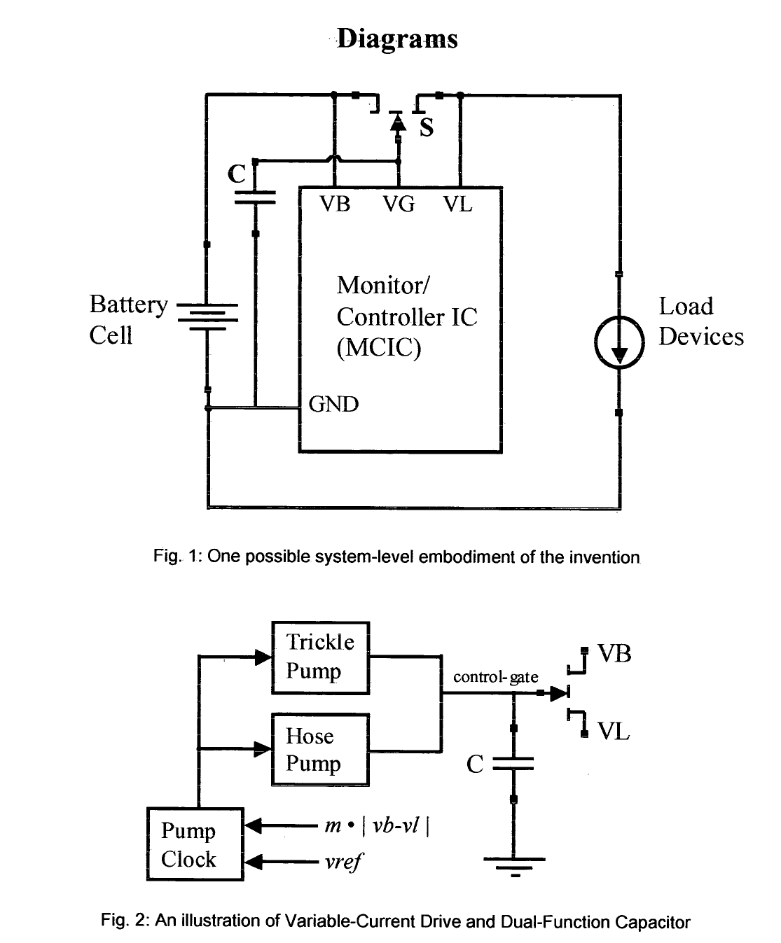

FIG. 1 shows key differences between the system embodiment and the prior art that include:
1. An enhancement-mode JFET employed as the switch device interrupting the battery cell circuit path within the battery pack,
2. The use of a capacitor connected to the control gate of the JFET switch device,
3. The elimination of a current measurement resistance in the batter cell circuit path, and
4. A Monitor/Controller integrated circuit (MCIC) with a reduced number of external pins.
   Dual-Function Capacitor

A key concept within the architecture of the invention is the use of a single external (potentially integrated monolithically) capacitor for two important functions. The capacitor C in FIG. 1 is connected to the control gate of the switch device S with a value determined by operating parameters. The two functions of the capacitor are:
1. A filter/charge reservoir function for the output of the drive circuits connecting to the control gate of the switch device and
2. A delay element that determines the time after a short-circuit or an over-current event at the output of the battery-pack after which the output of the battery-pack recovers to the nominal value determined by the voltage available in the battery cell.

As seen in FIG. 2, the capacitor C filters the outputs of two or more paralleled charge pumps. The charge pumps are integrated within the MCIC and serve the purpose of boosting the voltage to a value greater than the voltage of the battery cell such that a predetermined amount of current flows into the control junction depending upon the mode of operation of the battery-pack. For example, when the loads demand the nominal system current, the drive circuits (the charge pumps) will operate such as to provide a sufficient current flow into the junction so as to maintain the switch device S in it's full-ON condition. The capacitor C serves to smooth the voltage ripple generated by the active operation of the charge pumps. In another mode, where the loads are transitioned into a stand-by mode demanding a much lower load current value, the HOSE charge pump may be turned to it's OFF state (clocks disabled, for example) and the TRICKLE charge pump will continue to operate, providing a minimal amount of current to the junction gate that continues to maintain the switch device in it's ON state, but at a higher impedance value. The capacitor C again filters the output of the trickle charge pump and smoothes the voltage at the control gate of the switch device. This architecture ensures that the voltage at the control gate node remains very close to the level necessary for the drive action called for (much higher gate current) when the load demand suddenly increases. Device C also acts as a reservoir of charge that supplies a large control gate current when the load current demand increases suddenly, dropping the output node voltage. Thus device C serves the purposes of a filter component as well as that of a charge reservoir assisting in managing sudden load current demands. This architecture ensures that no active elements are present in the control action that ensures low impedance for switch device S during a sudden load current demand. The architecture therefore facilitates load switching at higher frequencies, or finer time-granularity in load current management within the system.

In the event of a short-circuit or a sustained over-current condition at the output of the battery pack, the capacitor C is discharged rapidly, assisted by the fault condition as well as a discharge transistor integrated into the MCIC, and is then recharged by a slow LEAK charge provided by a LEAK circuit within the MCIC. As long as the short-circuit remains in effect, the LEAK current flow combined with any reverse current flow (through the diode junction from the control gate to the terminal of the switch device connected to the battery cell) is designed to be insufficient to charge the control gate node. This ensures that the switch device remains in it's OFF state, since a voltage differential greater than the typical diode drop (in silicon substrates, ˜0.7V, or seven-tenths of a volt) is required to turn the switch device ON. When the short-circuit at the output of the battery-pack is removed, the control gate node begins charging up since there is no discharge path for the LEAK current driven into the control gate node. The time duration is dependent upon the value of the LEAK current and the value of the capacitor C as well as the voltage level it needs to charge to in order to restore nominal operation for the battery-pack. Thus device C functions as a delay element that, in conjunction with the circuits within the MCIC and the voltage of the battery cell, determines the time duration between the removal of a fault and the restoration of nominal operating conditions.

Detection & Management of Operational/Fault Conditions

All the terminals of the switch device of the battery-pack are accessible to the MCIC as shown in FIG. 1. The use of PN junction control gate devices requiring a gate current for conduction state transitions provides additional information in the value of the gate current.

The temperature-dependent variation of the voltage across PN junctions with a forward current flow through them is well known in the art and is exceptionally well exploited in silicon-bandgap based voltage references. This variation is a few mV/° C., and is current density dependent, and knowledge about this characteristic of the switch device gives an added dimension of information about the operational condition of the device. In other words, this circuit architecture that feeds a forward current into a PN junction gate of the switch device allows for the estimation of the temperature of the switch device while in operation. With appropriate packaging of the battery-pack, such as with a shared heat-conducting metal plate between the battery cell and the switch device, the MCIC can monitor the temperature of critical elements in the battery-pack employing the switch device in the additional role of a temperature sensor. The information on the switch device temperature available in the architecture of the invention greatly improves the accuracy of current measurement made using voltage information at the terminals of the switch device.

Over-Current (OC): A key fault is over-current that must be detected in both the charge and discharge modes of operation of the battery-pack. This is easily implemented in the invention using the voltage differential across the Source/Drain terminals. One possible algorithm for OC detection in the invention is detailed below.

The MCIC determines the primary operational mode of the battery-pack (BP) by detecting the value of the voltages and the polarity of the voltage differential between terminals VB and VL of the circuit shown in FIG. 1. The algorithm described below is one possible embodiment of the method of determining an over-current condition in the invention architecture. It is also not necessarily executed in the order in which the tests are listed.
a) If VB is greater than VL by a minimum amount (determined by the operational current values for the system), but not greater than the maximum amount (based on max. system current and the known switch device resistance) then the BP is in the discharge mode:
   i) If VL is near 0V, then the BP is in the shorted state, raising the fault flag to TRUE
   ii) If (VB−VL) is greater than the maximum differential, use (VG−VL), where VG is the control gate potential, to derive a compensated voltage drop so as to detect a true OC condition. If the modulated differential exceeds the maximum, then the fault flag is raised to TRUE.
b) If VL is greater than VB by the minimum amount, the BP is in the charge mode.
i) If VB is near 0V, then the battery cell is non-functional or shorted indicating a fault
ii) If (VL−VB) exceeds a pre-determined maximum, despite modulation of the sensed differential for temperature as described above, the fault flag is set to TRUE.
c) If VB is approximately the same as VL (within a certain range, say a few mV) then the BP is in the standby mode.

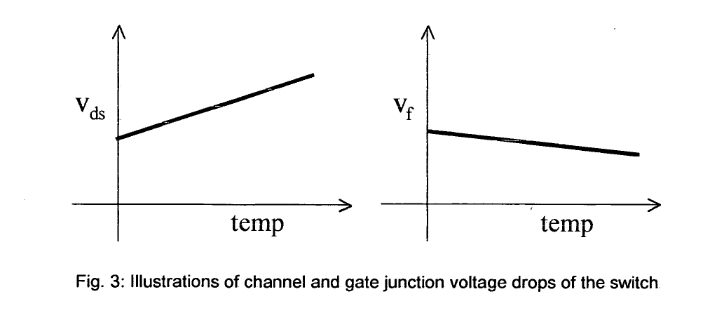

A distinguishing feature of the invention architecture is that it provides additional information in the form of a forward voltage across the gate PN junction that may be gainfully employed in an accurate determination of an over-current condition. Assuming that the resistance increase of the switch device with temperature is roughly linear, as illustrated in FIG. 3, the temperature dependent linear decrease in forward PN junction voltage (of 2 to 3 mV/° C.) can be used to cancel out the effect of the resistance variation.

An exception to this capability is when the battery-pack transitions from the standby mode into the full-discharge or OC mode. In this situation, the forward junction current is an indeterminate value, dependent upon the current pulled from the storage capacitor C into the junction, reducing the usefulness of the value of the forward voltage across the control gate junction diode. The test for over-current in this situation is done after the full control gate forward current is restored, which in the invention architecture, may amount to a few cycles of activity of the HOSE PUMP that is designed to deliver the control gate current for the full-on operational state of the switch.

Incorrect registration of over-current conditions, due to temperature-induced switch resistance increases or state-transitions that result in transient reductions of the load voltage is avoided in the invention without the use of a precision external or internal resistor employed in prior art.

Under-Voltage (UV) and Over-Voltage (OV): These fault conditions are detected with techniques akin to methods used in the prior art. The battery voltage at terminal VB is scaled appropriately and compared with an internal voltage reference developed based on the silicon bandgap. When a UV condition is detected, the discharge operational mode of the battery-pack is disallowed. Conversely, when an OV condition is detected, the charge mode is disallowed.

Over-Temperature (OT): The invention architecture allows the detection of the temperature of the switch device control gate junction through prior knowledge of the expected voltage value across the control gate junction for the various input forward currents that determine the operational modes of the switch device. The MCIC can therefore monitor the control gate junction voltage and determine if it has fallen below the minimum value expected, and register an OT condition. In an OT event, an embodiment of the invention may transition the battery-pack into the shutdown mode (that is entered into in the event of a critical fault), and then transition back to the nominal operating modes through the slow ramp-up of charge on the control gate capacitor C. This ensures that the switch device is protected from damage due to overheating during charging of the battery cell or when the system containing the battery pack is operated at high temperatures.

As explained in a previous section, with carefully designed packaging of the battery-pack it may be feasible to sense the temperature of the battery cell as well through the sharing of a conductive heat-spreading plate between the cell and the switch. This modification in combination with the OT sensing capability of the invention could potentially eliminate the thermo-mechanical circuit breaker often integrated into the battery cell.

Drive Circuits Architecture

Key aspects of the circuits that drive the control gate of the switch device S (FIG. 1) in the invention are described in this section. The architecture of the drive circuits determines the energy efficiency of the battery-pack in it's various modes of operation. For example, in the full-on mode, where the battery-pack is providing charge to an external load, the load current may vary significantly while still meeting the definition of a full-on condition. A system may require a peak-current of 1A as well as an idle-current of 100 mA, and various operating modes of the system may consume any load current value in between these two limits defined. The full-on operational mode specified for the battery-pack may require, for example, as much as 1 mA of control gate current input into switch device S, but will not need that amount of current output from the MCIC for the idle condition. An ability to modulate the control gate drive current is therefore necessary, to save power & energy.

Variable-Current Drive: FIG. 2 is an illustration of one possible embodiment of the concepts of the invention. As shown, the HOSE charge pump paralleled with a TRICKLE pump drive circuit that feeds current into the control gate node is enhanced with a variable clock source. This clock source varies its output frequency within a limited range determined by the modulated voltage differential across the switch device. The modulation is indicated by the factor m in the figure and is the scaling and correction for temperature differences as explained earlier in the Over-Current paragraph and algorithm. Under a valid operational mode such as discharge or charge, the circuit for variable current drive senses the current flow and modulates the clock proportionately. Larger current flows therefore speed up the pump clock and a smaller current flow slows it down. The circuit architecture may be thought of as a coarse drive current determination based on a pump selection and a fine or analog modulation of the chosen current range by the variation of the pump clock frequency. The clock frequency variation may be rendered continuous within the range by employing the voltage values received as an oscillator bias control. A reference voltage may be used in place of the modulated current-sense signal when the signal is out of range.

Alternate embodiments of the invention may have only one, or more than two of the drive pumps, providing for a lesser or greater range for the variable current drive. The charge outputs from the pumps may also be designed to be such as to provide an overlap between the operating ranges of the pumps, wherein a smaller pump operating at the maximum frequency may pump more charge per unit time, or provide more current than the next larger pump operating at the lower end of the pump clock frequency range.

An advantage of the variable current drive architecture is the ability to optimize the energy expenditure in the battery pack based on load current requirements. Together with the Dual-function Capacitor, it also provides an elegant timing solution for recovery from fault states.

Single-chip integration: Enhancement-mode JFET structures are quite easily created in standard CMOS process flows. Consider, for example, an N-Well CMOS process flow that creates P-type MOSFET devices within an n-well, this process uses a strongly p-doped silicon substrate. Planar JFET structures on such substrates have been shown to be feasible in reference [6], an application note published by Moxtek®. It will be apparent to those skilled in the art of fabricating electronic devices and integrated circuits that the integration of a JFET switch device with a planar CMOS process is feasible. While depletion JFET devices may be created with relative ease in such a process, enhancement devices may be created by positioning control gate ‘p+’ tubs close enough to each other such that the junction depletion regions overlap, blocking conduction in the channel between the gate tubs, when no external bias is provided across the gate PN junctions, and recede back toward the junctions as a forward external bias is applied, thus opening a conducting channel for the flow of current. This application of the prior art knowledge of the presence of intrinsic depletion regions in PN junctions as well as the properties of such regions is obvious.

The architecture of the invention that provides a controlled, small-value leak charge flow into the capacitor of the control gate allows for the value of the capacitor to be small for reasonable ‘auto-reset’ time durations. This enables the integration of the capacitor into a monolithic component. FIG. 1 also shows that the only components required are a switch device and a capacitor.

Although specific embodiments have been illustrated and described herein, any circuit arrangement configured to achieve the same purposes and advantages may be substituted in place of the specific embodiments disclosed. This disclosure by the inventor is intended to cover any and all adaptations or variations of the embodiments of the invention provided herein. All the descriptions provided in the specification have been made in an illustrative sense and should in no manner be interpreted in any restrictive sense. The scope, of various embodiments of the invention whether described or not, includes any other applications in which the structures, concepts and methods of the invention may be applied. The scope of the various embodiments of the invention should therefore be determined with reference to the appended claims, along with the full range of equivalents to which such claims are entitled. Similarly, the Abstract of this disclosure, provided in compliance with 37 CFR §1.72(b), is submitted with the understanding that it will not be interpreted to be limiting the scope or meaning of the claims made herein. While various concepts and methods of the invention are grouped together into a single ‘best-mode’ implementation in the detailed description, it should be appreciated that inventive subject matter lies in less than all features of any disclosed embodiment, and as the claims incorporated herein indicate, each claim is to viewed as standing on it's own as a preferred embodiment of the invention.

### Key Advantages of the Invention Over Prior Art

1. The invention minimizes the number of components required within a battery-pack. Specifically, it eliminates the need for a precision resistor used to accurately measure the current flow through the gating switch device.
2. The invention uses a capacitor for multiple, necessary functions simultaneously.
3. The invention uses and facilitates the use of enhancement-mode symmetric JFET devices.
4. An ability to estimate switch device junction temperature is provided by the invention through the switch terminal voltages and a known forward gate current.
5. A facility to optimize the energy consumed in various operational modes of the battery—pack is provided by a variable-current drive integrated within the monitor/controller chip.
6. An elegant technique employing a LEAK current drive into the control gate is provided to enable the battery-pack to recover from a short-circuit event with negligible power consumption. As compared with the prior art, this technique:
   a. Minimizes the value of the capacitance employed for an ‘auto-reset’ delay,
   b. Minimizes the consumption of the battery-cell energy in spite of a short.
7. By the elimination of a precision resistor and the minimization in the value of a capacitor employed, the invention enables low-cost, total integration of the protection circuits.

### REFERENCES

1. Brown, Paul M. Jr.; U.S. Pat. No. 4,228,367. “High speed integrated switching circuit for analog signals”, Issued: Oct. 14, 1980
2. Zwanziger, Peter; U.S. Pat. No. 4,987,362, “Self-regulating drive circuit for the base current of a power transistor with saturation level control”, Issued: Jan. 22, 1991
3. Williams Richard K.; U.S. Pat. No. 5,909,103, “Safety switch for lithium ion battery”, Issued: Jun. 1, 1999
4. Alwardi, Milad et. al.; U.S. Pat. No. 5,9650,997, “Battery monitoring circuit with storage of charge and discharge accumulation values accessible therefrom”, Issued: Oct. 12, 1999
5. Morrill, David P.; U.S. Pat. No. 6,249,148, “Low power variable base drive circuit”, Issued: Jun. 19, 2001
6. MOXTEK ™ Application Note “Low Noise Junction Field Effect Transistors”, Feb. '01
7. Technology and product information for JFET devices from Lovoltech Inc. at the following URL: http://www.lovoltech.com/products.htm

1. An electronic circuit apparatus, comprising:
Electronic devices and their interconnection that regulates the flow of current through a battery cell storing and providing an electromotive force;
An electronic switch device that blocks or allows the flow of current into and out of the battery cell, with a PN junction diode as its control gate, requiring the flow of current through it's PN junction gate to allow current flow through the channel of the device;
A dual-function capacitor connected between the control gate node of the switch device and a reference node in the circuit;
A variable-current drive sub-circuit that provides variable current flow through the control gate terminal of the switch device, and sub-circuits generating the required voltage to provide this variable current flow;
A monitor-controller sub-circuit that monitors the voltages at all circuit nodes and directs the variable-current drive sub-circuit to drive the minimum necessary current through the control gate terminal of the switch device.

2. A method for current flow estimation through the channel of a gating device within an electronic apparatus regulating the flow of current, comprising:
The application of a gating device comprising of a channel and a PN junction control gate requiring forward current flow to allow current conduction through the channel;
The registration and use of voltages at all terminals of the gating device with the switch device conducting the current to be estimated;
The computation of a compensated voltage drop value as a mathematical combination of scaled values of the differential voltage across the channel of the switch device and the forward voltage value across its PN junction control gate diode;
And the computation of the channel current using known switch device characteristics and the operating condition of the switch along with the compensated voltage drop.

3. A method for estimating device temperature within an electronic apparatus, comprising:
The application of a device with a PN junction as its control gate, where the PN junction requires a forward current through it for normal device operation;
The registration of the forward voltage drop across the PN junction diode control gate of the device with a known forward current supplied into the junction;
And a comparison of the forward voltage drop with known reference voltage values.

4. The apparatus of claim 1 where a variable current drive function is performed by any DC-to-DC conversion sub-circuit or any current or voltage source sub-circuit.

5. The apparatus of claim 1 where the sub-circuit providing the variable current drive comprises of a parallel combination of a multiplicity of charge pumps of varying current output capabilities.

6. The apparatus of claim 1, using one or more charge pumps for the variable current drive, where the pump clock frequencies are varied in relation to the gating switch current flow.

7. The apparatus of claim 1, using a charge pump, where the pump oscillator frequency is varied in a continuous manner by employing a compensated voltage drop voltage as a bias voltage within the oscillator sub-circuit.

8. The apparatus of claim 1, with a shared heat-spreading element connecting the bodies of the gating device and the battery cell, such that the respective temperature values are close to each other.

9. The apparatus of claim 1 where the gating switch device is any combination of one or more enhancement-mode junction field-effect transistor (JFET) devices.

10. The apparatus of claim 1 where the gating switch device is a bipolar junction transistor (BJT) device or any combination of BJT and enhancement-mode JFET devices.

11. The apparatus of claim 1 where the monitor-controller sub-circuit and the variable current drive sub-circuit are integrated into a single monolithic component (IC).

12. The apparatus of claim 1 where monitor-controller sub-circuit, the variable current drive sub-circuit as well as the capacitor are monolithically integrated into a single component.

13. The apparatus of claim 1 where various sub-circuits, the capacitor and the gating switch device are monolithically integrated into a single component.

14. The method of claim 2 where the computed compensated voltage drop value, for a fixed switch channel current, is substantially independent of temperature.

15. The method of claim 2 where the gating switch device is integrated monolithically with the reference generation circuits, providing reference switch devices that are similar in construction for comparison, thereby enabling process invariance for the current estimation.

16. The method of claim 3 where the known reference voltage values are derived in circuits using PN junction structures very similar to the PN junction gate of the switch device.

17. The method of claim 3 where the device whose temperature is to be estimated and the reference generation circuits are monolithically integrated, providing identical reference devices for comparison, thereby facilitating process invariance in the temperature estimation.

18. Electronic systems comprising of various integrated and discrete electronic circuits and devices, electro-chemical, electro-thermal, electro-mechanical and electro-optic devices that employ the apparatus of claim 1 in any embodiment.

19. Electronic systems comprising of various integrated and discrete electronic circuits and devices, electro-chemical, electro-thermal, electro-mechanical and electro-optic devices that employ the method of claim 2 in any embodiment.

20. Electronic systems comprising of various integrated and discrete electronic circuits and devices, electro-chemical, electro-thermal, electro-mechanical and electro-optic devices that employ the method of claim 3 in any embodiment.
